(19) United States
(12) Patent Application Publication
(10) Pub. No.: US 2026/0022200 A1
(43) Pub. Date: Jan. 22, 2026

(54) IONIC POLYMERIC RESIN COMPOSITIONS

(71) Applicant: Ecolab USA Inc., St. Paul, MN (US)

(72) Inventors: Ashish Dhawan, Aurora, IL (US); Carter Martin Silvernail, Lakeville, MN (US)

(21) Appl. No.: 18/986,250

(22) Filed: Dec. 18, 2024

Related U.S. Application Data
(60) Provisional application No. 63/611,622, filed on Dec. 18, 2023.

(51) Int. Cl. C08F 26/02; B01D 15/36; B01J 31/08; C02F 1/42; C02F 101/20; C02F 101/36

(52) U.S. Cl. CPC C08F 26/02; B01D 15/361; B01J 31/08; C02F 1/42; C02F 2101/20; C02F 2101/36

(57) ABSTRACT

The present disclosure is generally directed to polymers comprising repeat units having the structures of Formulae 1, 2, and 3. These polymers are used in methods of removing contaminants, including PFAS and heavy metals, from an aqueous fluid comprising contacting the aqueous fluid with the polymer and in methods of catalyzing an organic transformation comprising contacting a fluid with a catalytic amount of the polymer.

### CROSS-REFERENCE TO RELATED APPLICATIONS

This application claims priority to U.S. Provisional Patent Application Ser. No. 63/611,622 filed on Dec. 18, 2023, the disclosure of which is incorporated herein by reference in its entirety.

### FIELD OF INVENTION

The present disclosure provides polymeric ionic resin compositions synthesized by reacting a crosslinked chloromethylated polystyrene resin with a polyamine to produce an intermediate polymer; and installing ionic (anionic/cationic) groups on to the intermediate polymer by an aza-Michael addition reaction. The disclosed polymeric resins may be used for multiple industrial and institutional applications including removal of PFAS, heavy metals and other contaminants from water streams. These resins may also be used as polymeric acid/base catalysts for organic transformations.

### BACKGROUND OF INVENTION

PFAS (per- and polyfluoroalkyl substances) are a large group of synthetic organic compounds used in a wide variety of materials and industries. In the last several decades, concerns have emerged for how persistent these chemicals are in living organisms, where they have been associated with several human diseases, and the environment, particularly water sources. Water streams can also contain other contaminants, including heavy metals. Thus, there is a need to come up with improved ways to remove these contaminants from water sources.

Ion exchange resins are made of highly porous, polymeric materials typically formed as small beads having a diameter of 0.05 to 1.0 mm. The microbeads form an insoluble matrix, or support structure. Ion exchange sites are provided throughout the polymer matrix. Each ion exchange site includes a functional group of either positively-charged ions (cations) or negatively-charged ions (anions) affixed to the polymer network. These functional groups readily attract ions of an opposing charge. The trapping of such ions by the functional group, in conjunction with the accompanying release of other ions from the functional group, constitutes a process called ion exchange.

Several methods exist for PFAS removal. The most commonly used are granular activated carbon, high-pressure membrane systems, and ion exchange resins. Positively charged, strongly basic anion exchange resins have been proven effective in removing negatively charged contaminants, like PFASs, from water. The negatively charged ions of the PFAS are attracted to the positively charged anion resin, causing the PFAS to deposit onto the surface of the resin beads and in effect removing the PFAS from the water. However, there exists a need to develop new ionic resins that can remove various contaminants more effectively, efficiently, and/or at lower cost.

Additionally, ion exchange resins can be used as acid or base catalysts in various organic transformations including etherification, hydration, dehydration, esterification, alcoholysis, inversion of sugar, and the like. Many known ion exchange resins have limitations of temperature stability or other properties that are disadvantageous for certain reaction conditions. Accordingly, a need exists for new ion exchange resins that have stability under different conditions. cl SUMMARY OF INVENTION

The present disclosure provides a polymer comprising repeat units having the structures of Formulae 1, 2, and 3

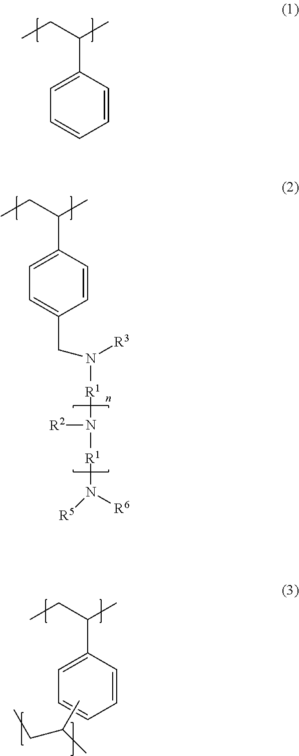

Wherein R¹ is C₁-C₁₀ alkylene; R² is hydrogen or —(CH₂)x—C(R¹⁰)—C(O)—X—Z; R³ is hydrogen or —(CH₂)x—C(R¹⁰)—C(O)—X—Z; R⁵ and R⁶ are independently hydrogen or —(CH₂)x—C(R¹⁰)—C(O)—X—Z; R¹⁰ is hydrogen, alkyl, aryl, or alkaryl; R¹¹, R¹², and R¹³ are independently C₁ to C₁₀ alkyl or alkaryl; X is NH or O; Z is hydrogen, L¹—NR¹¹R¹²R¹³, L²—PR¹¹R¹²R¹³, L³—COOH, L⁴—SO₃H, L⁵—PO₃H, or a salt thereof; and L¹, L², L³, L⁴, and L⁵ are independently C₁-C₁₀ alkylene or alkenylene; wherein the polymer comprises repeat unit of Formula 1 in an amount from 0 to 50 mole percent, Formula 2 in an amount from 30 to 99 mole percent, and Formula 3 in an amount from 1 to 20 mole percent, based on the total moles of the repeat units of Formula 1, Formula 2, and Formula 3.

For the polymers described herein, R¹ can independently be C₂-C₆ alkylene; R¹ can independently be C₂-C₄ alkylene; preferably, R¹ can be ethylene.

Additionally, the polymers described herein can have R² be —(CH₂)x—C(R¹⁰)—C(O)—X—Z.

Further, the polymers can have x be an integer from 1 to 6; x be an integer from 2 to 4, or preferably, x is 2.

Also, the polymers can have R¹⁰ be hydrogen, C₁ to C₃ alkyl or benzyl; preferably, R¹⁰ is hydrogen.

For the polymers described herein, X can be O or X can be NH.

Additionally, the polymers can have Z be hydrogen or L³—COOH, L⁴—SO₃H, L⁵—PO₃H, or a salt thereof.

Further, for the polymers, L³, L⁴, and L⁵ can be independently C₁ to C₆ alkylene.

Additionally, the polymers can have Z be hydrogen, L¹—NR¹¹R¹²R¹³, L²—PR¹¹R¹²R¹³, L³—COOH, L⁴—SO₃H, L⁵—PO₃H, or a salt thereof.

For the polymers described herein, L³, L⁴, and L⁵ can independently be C₁ to C₆ alkylene; or C₂ to C₃ alkylene.

The polymers can have R¹¹, R¹², and R¹³ independently be C₁ to C₁₀ alkyl or benzyl; independently C₁ to C₃ alkyl or benzyl; or methyl.

The disclosure is further directed to a method of removing contaminants from an aqueous fluid comprising contacting the aqueous fluid with an effective amount of the polymer disclosed herein.

Another aspect of the disclosure is a method of catalyzing an organic transformation comprising contacting a fluid with a catalytic amount of the polymer disclosed herein.

Other objects and features will be in part apparent and in part pointed out hereinafter.

### DETAILED DESCRIPTION OF INVENTION

There exists a need to develop ionic resins for use in multiple areas including removal of PFAS, heavy metals, and other contaminants from water streams. It was conceived by the inventors that the ionic groups can be installed onto the solid supported backbones such as crosslinked polystyrene employing alkylation and Michael addition reactions, and the resulting functionalized polymeric resin might be useful for such applications. These ionic resins could also potentially be used in Sanitizing (third sink) and/or disinfecting applications and reusable third sink sensors.

One aspect of the disclosure provides a polymer comprising repeat units having the structures of Formulae 1, 2, and 3

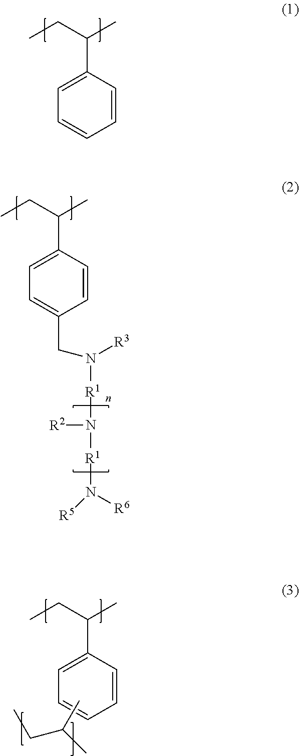

wherein R¹ is C₁-C₁₀ alkylene; R² is hydrogen or —(CH₂)x—C(R¹⁰)—C(O)—X—Z; R³ is hydrogen or —(CH₂)x—C(R¹⁰)—C(O)—X—Z; R⁵ and R⁶ are independently hydrogen or —(CH₂)x—C(R¹⁰)—C(O)—X—Z; R¹⁰ is hydrogen, alkyl, aryl, or alkaryl; R¹¹, R¹², and R¹³ are independently C₁ to C₁₀ alkyl or alkaryl; X is NH or O; Z is hydrogen, L¹—NR¹¹R¹²R¹³, L²—PR¹¹R¹²R¹³, L³—COOH, L⁴—SO₃H, L⁵—PO₃H, or a salt thereof; and L¹, L², L³, L⁴, and L⁵ are independently C₁-C₁₀ alkylene or alkenylene; wherein the polymer comprises repeat unit of Formula 1 in an amount from 0 to 50 mole percent, Formula 2 in an amount from 30 to 99 mole percent, and Formula 3 in an amount from 1 to 20 mole percent, based on the total moles of the repeat units of Formula 1, Formula 2, and Formula 3.

Additionally, the polymer can comprise repeat units having the structures of Formulae 10, 11 and 12:

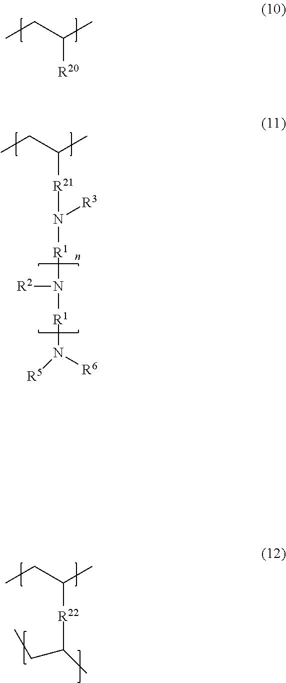

wherein R¹ is C₁-C₁₀ alkylene; R² is hydrogen or —(CH₂)x—C(R¹⁰)—C(O)—X—Z; R³ is hydrogen or —(CH₂)x—C(R¹⁰)—C(O)—X—Z; R⁵ and R⁶ are independently hydrogen or —(CH₂)x—C(R¹⁰)—C(O)—X—Z; R¹⁰ is hydrogen, alkyl, aryl, or alkaryl; R¹¹, R¹², and R¹³ are independently C₁ to C₁₀ alkyl or alkaryl; R²⁰ is hydrogen, halo, alkyl, aryl, or alkaryl; R²¹ is absent, alkyl, alkaryl, or aralkyl; R²² is alkylene, arylene, alkarylene, or aralkylene; X is NH or O; Z is hydrogen, L¹—NR¹¹R¹²R¹³, L²—PR¹¹R¹²R¹³, L³—COOH, L⁴—SO₃H, L⁵—PO₃H, or a salt thereof; L¹, L², L³, L⁴, and L⁵ are independently C₁-C₁₀ alkylene or alkenylene; wherein the polymer comprises repeat unit of Formula 10 in an amount from 0 to 50 mole percent, Formula 11 in an amount from 30 to 99 mole percent, and Formula 12 in an amount from 1 to 20 mole percent, based on the total moles of the repeat units of Formula 10, Formula 11, and Formula 12.

For the polymers described herein, R¹ can independently be C₂-C₆ alkylene; R¹ can independently be C₂-C₄ alkylene; preferably, R¹ can be ethylene.

Additionally, the polymers described herein can have R² be —(CH₂)x—C(R¹⁰)—C(O)—X—Z.

Further, the polymers can have x be an integer from 1 to 6; x be an integer from 2 to 4, or preferably, x is 2.

Also, the polymers can have R¹⁰ be hydrogen, C₁ to C₃ alkyl or benzyl; preferably, R¹⁰ is hydrogen.

For the polymers described herein, X can be O or X can be NH.

Additionally, the polymers can have Z be hydrogen or L³—COOH, L⁴—SO₃H, L⁵—PO₃H, or a salt thereof.

Further, for the polymers, L³, L⁴, and L⁵ can be independently C₁ to C₆ alkylene.

Additionally, the polymers can have Z be hydrogen, L¹—NR¹¹R¹²R¹³, L²—PR¹¹R¹²R¹³, L³—COOH, L⁴—SO₃H, L⁵—PO₃H, or a salt thereof.

For the polymers described herein, L³, L⁴, and L⁵ can independently be C₁ to C₆ alkylene; or C₂ to C₃ alkylene.

The polymers can have R¹¹, R¹², and R¹³ independently be C₁ to C₁₀ alkyl or benzyl; independently C₁ to C₃ alkyl or benzyl; or methyl.

The polymers comprising repeat units of Formulae 11, 12, and 13 can have R²⁰ be hydrogen, chloro, aryl, or alkaryl. Preferably, R²⁰ is hydrogen, chloro, phenyl, or benzyl.

Additionally, the polymers comprising repeat units of Formulae 11, 12, and 13 can have R²¹ be absent, C₁-C₆ alkylene, C₁-C₃ alkylene, or arylene (e.g., phenylene). Preferably, R²¹ is absent, methylene, or phenylene.

The polymers comprising repeat units of Formulae 11, 12, and 13 can have R²² be C₁-C₈ alkylene, or arylene.

The polymer having repeat units of Formulae 1, 2, and 3 can have the following structure:

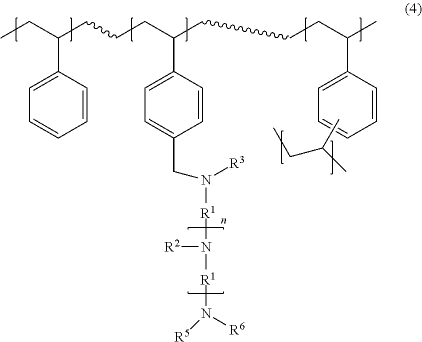

wherein R¹, R², R³, R⁵, and R⁶ are as defined above and the wavy lines represent that the repeat units can be in any order, particularly either a random copolymer or a block copolymer.

Additionally, the polymer having repeat units of Formulae 10, 11, and 12 can have the following structure:

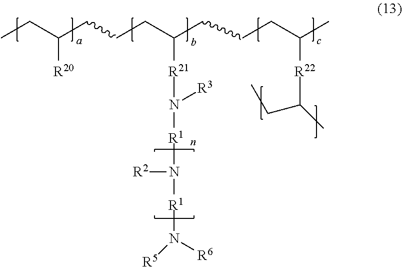

wherein R¹, R², R³, R⁵, R⁶, R²⁰, R²¹, and R²² are as defined above and the wavy lines represent that the repeat units can be in any order, particularly either a random copolymer or a block copolymer.

The disclosure is further directed to a method of removing contaminants from an aqueous fluid comprising contacting the aqueous fluid with an effective amount of the polymer disclosed herein. The contaminant can be perfluoroalkyl and polyfluoroalkyl substances. The contaminant can be a heavy metal.

A process for removing perfluoroalkyl and/or polyfluoroalkyl substances from a fluid can include providing an ion exchange system having a column defining an internal volume, and a bed of beads of the polymer discloses herein disposed in the internal volume; and introducing the fluid into the column so that the fluid contacts the polymer beads.

Additionally, the fluid to be treated can be introduced into the column so that the fluid contacts the polymer beads and includes introducing the fluid into the column so that the fluid contacts the polymer beads for a length of time sufficient to cause the perfluoroalkyl and/or polyfluoroalkyl substances to become deposited on the polymer beads.

Introducing the fluid into the column so that the fluid contacts the polymer beads for a length of time sufficient to cause the perfluoroalkyl and/or polyfluoroalkyl substances to become deposited on the dimethylethanolamine resin includes controlling a flow rate of the fluid to be treated through the column.

Also, introducing the fluid into the column so that the fluid contacts the polymer beads includes introducing the fluid into the column so that the fluid passes through the bed of polymer beads.

A process for purifying water includes placing the water in contact with polymer beads described herein for a period of time sufficient to remove perfluoroalkyl and/or polyfluoroalkyl substances from the water.

Further, placing the water in contact with polymer beads for a period of time sufficient to remove perfluoroalkyl and/or polyfluoroalkyl substances from the water includes placing the water in contact with the polymer beads for a period of time sufficient for the perfluoroalkyl and/or polyfluoroalkyl substances to become deposited on the polymer beads.

Also disclosed is an ion exchange system for removing perfluoroalkyl and/or polyfluoroalkyl substances from a fluid that includes a column defining an internal volume; a bed of polymer beads disposed in the internal volume; and a valve system configured to, during operation, control a flowrate of the fluid through the column.

Further, the valve system includes an inlet valve configured to meter an inflow of the fluid into the internal volume; and an outlet valve configured to meter an outflow of the fluid from the internal volume.

The system also includes a controller configured to control opening and closing of the inlet and outlet valves.

Another aspect of the disclosure is a method of catalyzing an organic transformation comprising contacting a fluid with a catalytic amount of the polymer disclosed herein.

### Synthesis of Polymers

The polymers described above can be prepared from polymers that are commercially available (e.g., Poly(styrene-co-vinylbenzylchloride-co-divinylbenzene)) or the polymers can be prepared by reacting the starting monomers neat or in an appropriate solvent to prepare a crosslinked copolymer. For example, the first step to make the polymer comprising repeat units of Formulae 1, 2, and 3 are to place the following monomers, M1, M2, and M3 in a reaction vessel with a polymerization initiator to prepare the polymer of Formula 5:

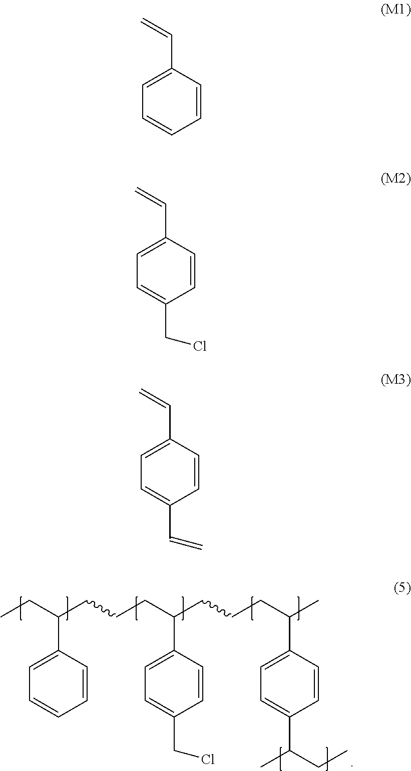

Additionally, the polymer of Formula 5 can be reacted with an amine of Formula 6 to form the intermediate polymer of Formula 4A.

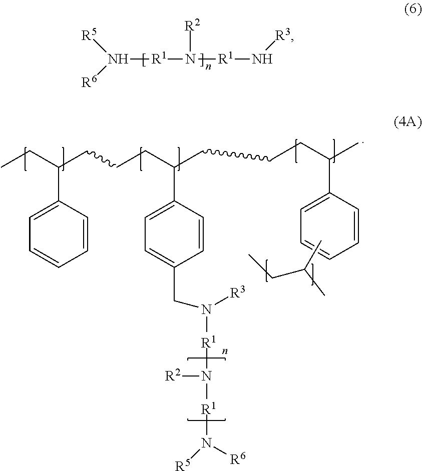

wherein R², R³, R⁵, and R⁶ are hydrogen in the amine of Formula 6 and intermediate polymer 4A.

The intermediate polymer 4A is then reacted with the vinyl carboxylate of Formula 7

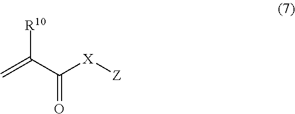

to form the polymer of Formula 4 wherein R², R³, R^{5,} and R⁶ are hydrogen or —(CH₂)x—C(R¹⁰)—C(O)—X—Z, where x is 1 and the rest of the variables are defined above.

Additionally, the first step to make the polymer comprising repeat units of Formulae 10, 11, and 12 are to place the following monomers, M10, M11, and M12 in a reaction vessel with a polymerization initiator to prepare the polymer of Formula 14:

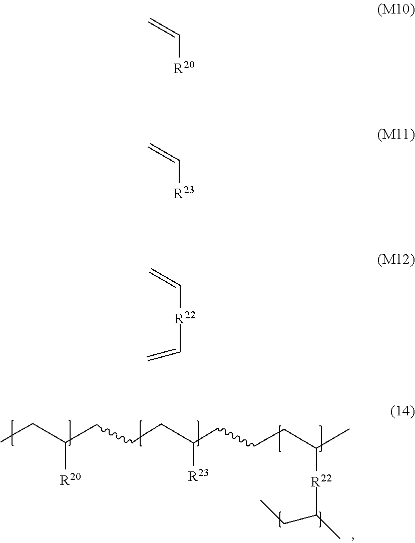

wherein R²⁰ and R²² are defined above and R²³ is halo, alkyl halide, aryl halide, or aryl vinyl halide.

Additionally, the polymer of Formula 14 can be reacted with an amine of Formula 6 to form the intermediate polymer of Formula 13A.

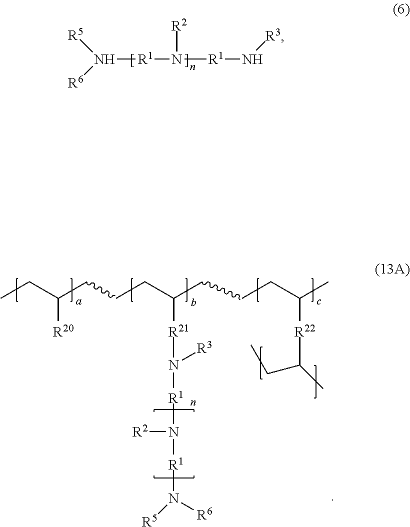

wherein R², R³, R⁵, and R⁶ are hydrogen in the amine of Formula 6 and intermediate polymer 13A.

The intermediate polymer 13A is then reacted with the vinyl carboxylate of Formula 7

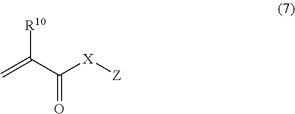

to form the polymer of Formula 13 wherein R², R³, R⁵, and R⁶ are hydrogen or —(CH₂)x—C(R¹⁰)—C(O)—X—Z, where x is 1 and the rest of the variables are defined above.

The term “alkyl,” as used herein, refers to a linear or branched hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons). Alkyl groups include, but are not limited to, methyl, ethyl, n-propyl, isopropyl, n-butyl, iso-butyl, secondary-butyl, and tertiary-butyl. Alkyl groups may be unsubstituted or substituted by one or more suitable substituents, as defined above.

The term “alkenyl,” as used herein, refers to a straight or branched hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, and having one or more carbon-carbon double bonds. Alkenyl groups include, but are not limited to, ethenyl, 1-propenyl, 2-propenyl (allyl), iso-propenyl, 2-methyl-1-propenyl, 1-butenyl, and 2-butenyl. Alkenyl groups may be unsubstituted or substituted by one or more suitable substituents, as defined above.

The term “alkoxy,” as used herein, refers to an alkyl group, as defined herein, appended to the parent molecular moiety through an oxygen atom.

The term “aryl,” as used herein, means monocyclic, bicyclic, or tricyclic aromatic radicals such as phenyl, naphthyl, tetrahydronaphthyl, indanyl and the like; optionally substituted by one or more suitable substituents, preferably 1 to 5 suitable substituents, as defined above.

The term “cycloalkyl,” as used herein, refers to a mono, bicyclic or tricyclic carbocyclic radical (e.g., cyclopropyl, cyclobutyl, cyclopentyl, cyclohexyl, cycloheptyl, cyclooctyl, cyclononyl, cyclopentenyl, cyclohexenyl, bicyclo[2.2.1]heptanyl, bicyclo[3.2.1]octanyl and bicyclo[5.2.0]nonanyl, etc.); optionally containing 1 or 2 double bonds. Cycloalkyl groups may be unsubstituted or substituted by one or more suitable substituents, preferably 1 to 5 suitable substituents, as defined above.

The term “halo” or “halogen,” as used herein, refers to a fluoro, chloro, bromo or iodo radical.

The term “heteroaryl,” as used herein, refers to a monocyclic, bicyclic, or tricyclic aromatic heterocyclic group containing one or more heteroatoms (e.g., 1 to 3 heteroatoms) selected from O, S and N in the ring(s). Heteroaryl groups include, but are not limited to, pyridyl, pyrazinyl, pyrimidinyl, pyridazinyl, thienyl, furyl, imidazolyl, pyrrolyl, oxazolyl (e.g., 1,3-oxazolyl, 1,2-oxazolyl), thiazolyl (e.g., 1,2-thiazolyl, 1,3-thiazolyl), pyrazolyl, tetrazolyl, triazolyl (e.g., 1,2,3-triazolyl, 1,2,4-triazolyl), oxadiazolyl (e.g., 1,2,3-oxadiazolyl), thiadiazolyl (e.g., 1,3,4-thiadiazolyl), quinolyl, isoquinolyl, benzothienyl, benzofuryl, and indolyl. Heteroaryl groups may be unsubstituted or substituted by one or more suitable substituents, preferably 1 to 5 suitable substituents, as defined above.

The term “heterocycle” or “heterocyclyl,” as used herein, refers to a monocyclic, bicyclic, or tricyclic group containing 1 to 4 heteroatoms selected from N, O, S(O)n, P(O)n, PRz, NH or NRz, wherein Rz is a suitable substituent. Heterocyclic groups optionally contain 1 or 2 double bonds. Heterocyclic groups include, but are not limited to, azetidinyl, tetrahydrofuranyl, imidazolidinyl, pyrrolidinyl, piperidinyl, piperazinyl, oxazolidinyl, thiazolidinyl, pyrazolidinyl, thiomorpholinyl, tetrahydrothiazinyl, tetrahydro-thiadiazinyl, morpholinyl, oxetanyl, tetrahydrodiazinyl, oxazinyl, oxathiazinyl, indolinyl, isoindolinyl, quinuclidinyl, chromanyl, isochromanyl, and benzoxazinyl. Examples of monocyclic saturated or partially saturated ring systems are tetrahydrofuran-2-yl, tetrahydrofuran-3-yl, imidazolidin-1-yl, imidazolidin-2-yl, imidazolidin-4-yl, pyrrolidin-1-yl, pyrrolidin-2-yl, pyrrolidin-3-yl, piperidin-1-yl, piperidin-2-yl, piperidin-3-yl, piperazin-1-yl, piperazin-2-yl, piperazin-3-yl, 1,3-oxazolidin-3-yl, isothiazolidine, 1,3-thiazolidin-3-yl, 1,2-pyrazolidin-2-yl, 1,3-pyrazolidin-1-yl, thiomorpholin-yl, 1,2-tetrahydrothiazin-2-yl, 1,3-tetrahydrothiazin-3-yl, tetrahydrothiadiazin-yl, morpholin-yl, 1,2-tetrahydrodiazin-2-yl, 1,3-tetrahydrodiazin-1-yl, 1,4-oxazin-2-yl, and 1,2,5-oxathiazin-4-yl. Heterocyclic groups may be unsubstituted or substituted by one or more suitable substituents, preferably 1 to 3 suitable substituents, as defined above.

The term “hydroxy,” as used herein, refers to an —OH group.

The term “suitable substituent,” as used herein, is intended to mean a chemically acceptable functional group, preferably a moiety that does not negate the activity of the inventive compounds. Such suitable substituents include, but are not limited to halo groups, perfluoroalkyl groups, perfluoroalkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl—and dialkylamino groups, carbamoyl groups, alkylcarbonyl groups, alkoxycarbonyl groups, alkylaminocarbonyl groups, dialkylamino carbonyl groups, arylcarbonyl groups, aryloxycarbonyl groups, alkylsulfonyl groups, and arylsulfonyl groups. Those skilled in the art will appreciate that many substituents can be substituted by additional substituents.

Having described the invention in detail, it will be apparent that modifications and variations are possible without departing from the scope of the invention defined in the appended claims.

### EXAMPLES

It is to be understood that while the invention has been described in conjunction with the detailed description thereof, the preceding description is intended to illustrate and not limit the scope of the invention, which is defined by the scope of the appended claims. Other aspects, advantages, and modifications are within the scope of the following claims.

### Example 1: General Synthesis

Disclosed ionic polymer resin compositions are prepared in two steps.

Step-1: Poly(styrene-co-vinylbenzylchloride-co-divinylbenzene) (I) is first reacted with a diamine or polyamine (II) to obtain an amine-functionalized resin backbone (III), wherein a is 0 to 50 mole percent, b is 30 to 99 mole percent, and c 1 to 20 mole percent based on the total moles of the polymer. Additionally, while the polymer repeat units are drawn in a particular order of attachment, the order of attachment for the repeat units can be random or block or any order.

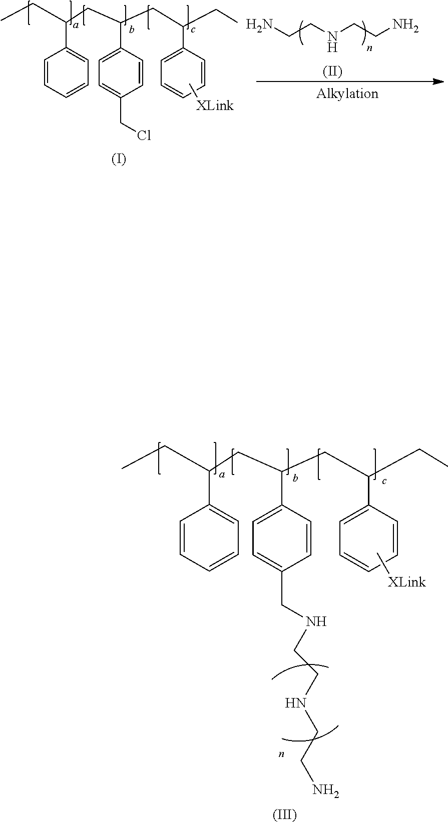

Step-2: Second step involves aza-Michael addition reaction between intermediate (III) and α,β-unsaturated carbonyl compound containing at least one polar (charged) group (NR³R⁴R⁵⁽⁺⁾X⁽⁻⁾, —COOH, —SO₃H, —PO₃H, or a salt thereof) (IV) to afford ionic polymer resin compositions (V).

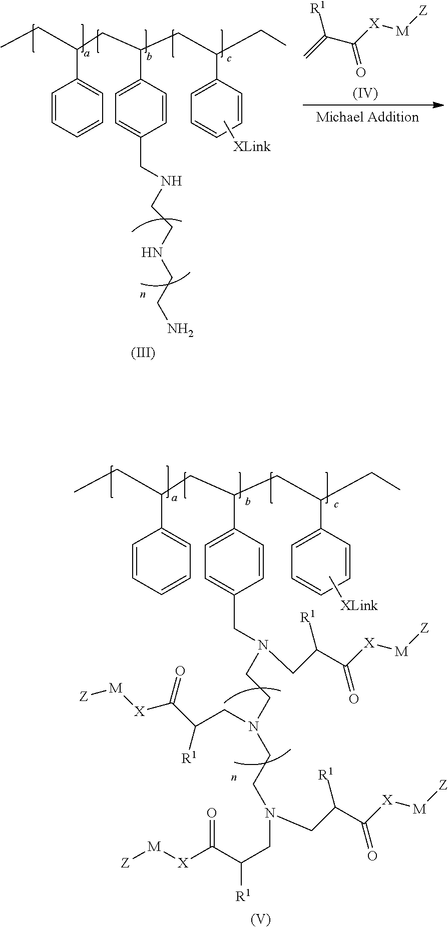

Wherein X is NH or O; R¹ is H, CH₃, or an unsubstituted, linear or branched C₂-C₁₀ alkyl group; M is absent or an unsubstituted, linear C₁-C₃₀ alkylene group; Z is —NR³R⁴R⁵⁽⁺⁾, —PR³R⁴R⁵⁽⁺⁾, Y⁽⁻⁾, —COOH, —SO₃H, —PO₃H, or a salt thereof; R³, R⁴, and R⁵ are independently C₁-C₁₀ alkyl group or benzyl group; and Y is a halide or another anion.

### Example 2: Representative Synthesis

Disclosed ionic polymer resin compositions are prepared in two steps.

Backbone alkylation reaction with polyamine: Poly(styrene-co-vinylbenzylchloride-co-divinylbenzene) (Cl− density=˜5.1 mmol/g, 50 g) was charged into a 250 mL three neck flask equipped with a mechanical stirrer, and purge valve. Dimethylformamide (150 ml) was added into the flask and stirred to form a viscous slurry of polymer resin. Pentaethyleneamine (PEHA, 70 g) was then added and the resulting mixture was stirred at 95° C. for 18 hours. After cooling, the reaction mixture was filtered using a fritted glass funnel under vacuum, washed sequentially with de-ionized water and ethanol, and finally air dried.

Michael addition reaction to install ionic-groups on polymeric backbone: PEHA-functionalized poly (styrene-co-vinylbenzylchloride-co-divinylbenzene) resin (20.25 g) resin was charged into a 250 mL flask containing 100 mL DI water. Acrylic acid (11.6 g) was gradually added into the flask under stirring. The slurry was gently stirred at 85° C. for 18 hours. The mixture was then filtered using fritted glass funnel under vacuum and then washed repeatedly with de-ionized water until the effluent was neutral. The beads were finally washed with ethanol and air dried.

The terms “comprise(s),” “include(s),” “having,” “has,” “can,” “contain(s),” and variants thereof, as used herein, are intended to be open-ended transitional phrases, terms, or words that do not preclude the possibility of additional steps or components. The singular forms “a,” “and,” “the” and “said” include plural references unless the context clearly dictates otherwise. The present disclosure also contemplates other embodiments “comprising,” “consisting of” and “consisting essentially of,” the embodiments or elements presented herein, whether explicitly set forth or not.

In view of the above, it will be seen that the several objects of the invention are achieved and other advantageous results attained.

As various changes could be made in the above compositions and processes without departing from the scope of the invention, it is intended that all matter contained in the above description shall be interpreted as illustrative and not in a limiting sense.

What is claimed is:

1. A polymer comprising repeat units having the structures of Formulae 1, 2, and 3 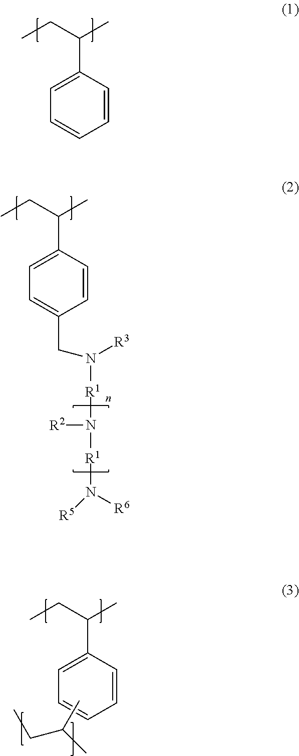
wherein
R¹ is C₁-C₁₀ alkylene;
R² is hydrogen or —(CH₂)x—C(R¹⁰)—C(O)—X—Z;
R³ is hydrogen or —(CH₂)x—C(R¹⁰)—C(O)—X—Z;
R⁵ and R⁶ are independently hydrogen or —(CH₂)x—C(R¹⁰)—C(O)—X—Z;
R¹⁰ is hydrogen, alkyl, aryl, or alkaryl;
R¹¹, R¹², and R¹³ are independently C₁ to C₁₀ alkyl or alkaryl;
X is NH or O;
Z is hydrogen, L¹—NR¹¹R¹²R¹³, L²—PR¹¹R¹²R¹³, L³—COOH, L⁴—SO₃H, L⁵—PO₃H, or a salt thereof; and
L¹, L², L³, L⁴, and L⁵ are independently C₁-C₁₀ alkylene or alkenylene;
wherein the polymer comprises repeat unit of Formula 1 in an amount from 0 to 50 mole percent, Formula 2 in an amount from 30 to 99 mole percent, and Formula 3 in an amount from 1 to 20 mole percent, based on the total moles of the repeat units of Formula 1, Formula 2, and Formula 3.

2. The polymer of claim 1, wherein R¹ is independently C₂-C₆ alkylene.

3. The polymer of claim 1, wherein R¹ is independently C₂-C₄ alkylene.

4. The polymer of claim 1, wherein R¹ is ethylene.

5. The polymer of any one of claims 1 to 4, wherein R² is —(CH₂)x—C(R¹⁰)—C(O)—X—Z.

6. The polymer of claim 5, wherein x is 1 to 6.

7. The polymer of claim 5, wherein x is 2 to 4.

8. The polymer of claim 5, wherein x is 2.

9. The polymer of any one of claims 1 to 8, wherein R¹⁰ is hydrogen, C₁ to C₃ alkyl or benzyl.

10. The polymer of claim 9, wherein R¹⁰ is hydrogen.

11. The polymer of any one of claims 1 to 10, wherein X is O.

12. The polymer of claim 11, wherein Z is hydrogen or L³—COOH, L⁴—SO₃H, L⁵—PO₃H, or a salt thereof.

13. The polymer of claim 12, wherein L³, L⁴, and L⁵ are independently C₁ to C₆ alkylene.

14. The polymer of claim 11, wherein Z is hydrogen, or absent.

15. The polymer of any one of claims 1 to 10, wherein X is NH.

16. The polymer of claim 15, wherein Z is L¹—NR¹¹R¹²R¹³, L²—PR¹¹R¹²R¹³, L³—COOH, L⁴—SO₃H, L⁵—PO₃H, or a salt thereof.

17. The polymer of claim 16, wherein L³, L⁴, and L⁵ are independently C₁ to C₆ alkylene.

18. The polymer of claim 16, wherein L³, L⁴, and L⁵ are independently C₂ to C₃ alkylene.

19. The polymer of any one of claims 16 to 18, wherein R¹¹, R¹², and R¹³ are independently C₁ to C₁₀ alkyl or benzyl.

20. The polymer of any one of claims 15 to 19, wherein Z is L¹—NR¹¹R¹²R¹³ and R¹¹, R¹², and R¹³ are independently C₁ to C₃ alkyl or benzyl.

21. The polymer of claim 20, wherein Z is L¹—NR¹¹R¹²R¹³ and R¹¹, R¹², and R¹³ are methyl.

22. A method of removing contaminants from an aqueous fluid comprising contacting the aqueous fluid with an effective amount of the polymer of any one of claims 1 to 21.

23. The method of claim 22, wherein the contaminant is perfluoroalkyl and polyfluoroalkyl substances.

24. The method of claim 22, wherein the contaminant is a heavy metal.

25. A method of catalyzing an organic transformation comprising contacting a fluid with a catalytic amount of the polymer of any one of claims 1 to 21.
